(19) United States
(12) Patent Application Publication
(10) Pub. No.: US 2014/0181434 A1
(43) Pub. Date: Jun. 26, 2014

(54) INTEGRATED AND NATURALIZED STATIC WEAR-LEVELING FOR BLOCK MAPPING

(71) Applicants: Trevor Chau, Westminster, CA (US); Lan Dinh Phan, Trabuco Canyon, CA (US)

(72) Inventors: Trevor Chau, Westminster, CA (US); Lan Dinh Phan, Trabuco Canyon, CA (US)

(73) Assignee: Virtium Technology, Inc., Rancho Santa Margarita, CA (US)

(21) Appl. No.: 13/722,556

(22) Filed: Dec. 20, 2012

(51) Int. Cl. G06F 12/16

(52) U.S. Cl. CPC G06F 12/16
USPC 711/162

(57) ABSTRACT

An embodiment is a technique to perform static wear leveling in a flash device. A first static block is popped from front of a first-in-first-out (FIFO) static pool when a static wear leveling condition is met. Data are copied from the first static block into an erased block to form a new block. The new block is pushed to end of the FIFO static pool. The static pool is part of a current static set and a next static set.

Another embodiment is a technique to maintain a FIFO static pool. All valid data are consolidated when a data collection condition is met. An erased block is selected from a free set. All consolidated data are copied into the erased block to form a new block. The new block is pushed into the FIFO static pool.

### TECHNICAL FIELD

The presently disclosed embodiments are directed to the field of flash devices, and more specifically, to wear-leveling in flash devices.

### BACKGROUND

Flash memory devices (e.g., NAND flash devices) have become increasingly popular in data storage for computer systems, mobile devices, consumer devices (e.g., cameras). In a typical flash device, there is a limit on the number of program and erase cycles. Exceeding this limit may cause the device to prematurely wear out, leading to unreliable results.

Wear-leveling is a technique that helps reduce premature wear in flash devices (e.g., NAND flash devices). In a typical device, not all the blocks in the memory are used equally. Some blocks may be programmed/erased more often than others. The basic idea of wear-leveling is to spread the use of the memory cells over the available memory array so that all the blocks in the memory are equally used, leading to a longer life.

Typically, there are two types of wear leveling: dynamic and static. There are also two types of data: static data, or cold data, are data that are relatively stable (unchanged); and dynamic data, or hot data, are data that may be updated or modified frequently. In dynamic wear leveling, a block having the least erase count is selected for the next write. In static wear leveling, the static (or cold) data are periodically moved to blocks with high erase counts. Each of these techniques has advantages and disadvantages. The dynamic wear leveling is easy to implement but it may not optimize the device life. The static wear leveling may lengthen the device life more and provides more efficient use of the memory array, compared to the dynamic leveling; however, it may slow the write operations and requires more controller overhead. Both of these techniques also suffer a common disadvantage that they are not tailored to the natural usage of the blocks in the device. They are usually treated as two separate concepts aiming at two different objectives. Accordingly, the memory array may not be most efficiently used and the device life may not be fully maximized.

### SUMMARY

One disclosed feature of the embodiments is a technique to perform static wear leveling in a flash device. A first static block is popped from front of a first-in-first-out (FIFO) static pool when a static wear leveling condition is met. Data are copied from the first static block into an erased block to form a new block. The new block is pushed to end of the FIFO static pool. The static pool is part of a current static set and a next static set. Another embodiment is a technique to maintain a FIFO static pool. All valid data are consolidated when a data collection condition is met. An erased block is selected from a free set. All consolidated data are copied into the erased block to form a new block. The new block is pushed into the FIFO static pool.

### BRIEF DESCRIPTION OF THE DRAWINGS

Embodiments may best be understood by referring to the following description and accompanying drawings that are used to illustrate embodiments. In the drawings:

FIG. 1 is a diagram illustrating a system according to one embodiment.

FIG. 2 is a diagram illustrating an integrated wear level circuit according to one embodiment.

FIG. 3A is a diagram illustrating the sets for the blocks according to one embodiment.

FIG. 3B is a diagram illustrating a state diagram for the set classification according to one embodiment.

FIG. 4 is a flowchart illustrating a process to perform an integrated wear level operation according to one embodiment.

FIG. 5 is a flowchart illustrating a process to perform an integrated and naturalized wear leveling according to one embodiment.

FIG. 6 is a flowchart illustrating a process to classify a block according to one embodiment.

FIG. 7 is a flowchart illustrating a process to perform a static wear leveling according to one embodiment.

FIGS. 8A, 8B, and 8C are diagrams illustrating the use of a first-in-first-out (FIFO) structure for static wear leveling according to one embodiment.

FIG. 9 is a flowchart illustrating a process to perform static wear leveling using the FIFO structure according to one embodiment.

FIG. 10 is a flowchart illustrating a process to maintain the FIFO static pool according to one embodiment.

### DETAILED DESCRIPTION

One disclosed feature of the embodiments is a technique to perform static wear leveling in a flash device. A first static block is popped from front of a first-in-first-out (FIFO) static pool when a static wear leveling condition is met. Data are copied from the first static block into an erased block to form a new block. The new block is pushed to end of the FIFO static pool. The static pool is part of a current static set and a next static set.

Another embodiment is a technique to maintain a FIFO static pool. All valid data are consolidated when a data collection condition is met. An erased block is selected from a free set. All consolidated data are copied into the erased block to form a new block. The new block is pushed into the FIFO static pool.

In the following description, numerous specific details are set forth. However, it is understood that embodiments may be practiced without these specific details. In other instances, well-known circuits, structures, and techniques have not been shown to avoid obscuring the understanding of this description.

One disclosed feature of the embodiments may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc. One embodiment may be described by a schematic drawing depicting a physical structure. It is understood that the schematic drawing illustrates the basic concept and may not be scaled or depict the structure in exact proportions.

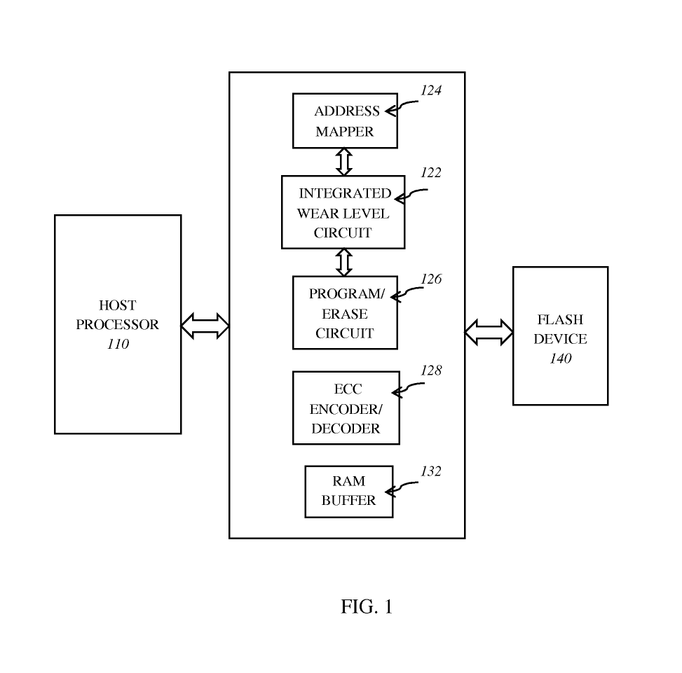

FIG. 1 is a diagram illustrating a system 100 according to one embodiment. The system 100 includes a host processor 110, a flash controller 120, and a flash device 140. The system 100 may include more or less than the above components. For example, the flash controller 120 may be integrated with the host processor 110, or components in the flash controller 120 may be separately implemented, or there may be additional peripheral devices or controllers that are connected to the processor 110 such as a network device, a set of memory devices, etc.

The host processor 110 may be a general-purpose microprocessor, a digital signal processor (DSP), a special-purpose processor, an embedded controller, or any programmable device or processor that may execute a program or a set of instructions. The flash controller 120 may be any device or processor that is designed to interface to the flash device 140 for the purpose of controlling the operations on the flash device 140. The flash controller 120 may be implemented in hardware, software, firmware, or any combination of hardware, software, and firmware. The flash controller 120 may include an integrated wear level circuit 122, an address mapper 124, a program/erase circuit 126, an error correcting code (ECC) encoder/decoder 128, and a random access memory (RAM) buffer 132. The flash controller 120 may include more or less than the above components. In addition, these components may be separated from each other, or integrated fully or partly into the host processor 110.

The integrated wear level circuit 122 provides wear leveling to the flash device 140. The wear leveling is performed based on an intuitive approach and therefore provides a more realistic solution to the wear-out problems in flash devices compared to traditional techniques. The technique is centered on the concept of sets of blocks and built upon the actual progress of these blocks as they go through the several phases of write and erasure cycles. The result is a highly integrated and naturalized wear leveling that integrate both dynamic and static wear leveling procedures. The technique is flexible and may be modified to accommodate any particular dynamic or static wear level procedures. The blocks in these sets may be from any suitable block organization schemes, including linked blocks, superblocks. Each block may correspond to a logical block that is mapped to a physical block or a group of logical blocks (e.g., adjacent logical blocks) that may be mapped to a group of physical blocks. The smallest unit in a block that can be mapped is called a quantum. The address mapper 124 maps or translates a logical quantum address (LQA) issued from the host processor 110 to a physical quantum address (PQA) that is used to specifically address the quantum in the flash device 140. It may be implemented as a look-up table or any other convenient and efficient mapping technique. The address mapper 124 may receive the LQA directly from the host processor 110 or from the integrated wear level circuit 122. The program/erase circuit 126 generates special pulses and voltage level shifting and timing and control signals to perform block erasure and program/write to the flash device 140. The ECC encoder/decoder 120 encodes and decodes error correcting code for the read/write data from and to the flash device 140. The RAM buffer 132 stores temporary data read from or written to the flash device 140. The flash device 140 may be any semiconductor flash memory device such as a NAND flash memory, a NOR flash memory. It may be a single die or a multiple die device. Typically, the flash device 140 may be used as a solid state drive (SSD). The flash device 140 may be organized in any configurations, such as 512 Mb to 128 Gb density, block size from 16K to 512K, page size from 512 to 8K, etc.

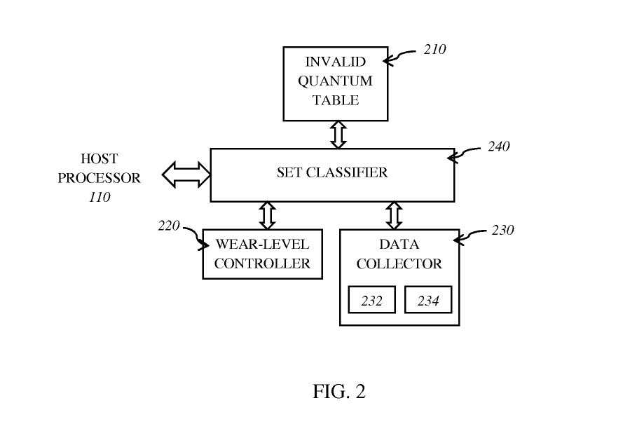

FIG. 2 is a diagram illustrating the integrated wear level circuit 122 shown in FIG. 1 according to one embodiment. The integrated wear level circuit 122 may include an invalid quantum table (IQT) 210, a wear-level controller 220, a data collector 230, and a set classifier 240. The integrated wear level circuit 122 may include more or less than the above components.

The IQT 210 may store invalid information on quanta in a plurality of blocks in the flash device 140. The quantum is the smallest unit that can be mapped from one block to another block. The quantum is usually much smaller in size than the block, which is the basic unit for erasure. As an illustration, in one embodiment, the quantum is a page. In other embodiments, the quantum may be of any size and its designation depends on the type of mapping mechanism. A quantum may have three states: valid, invalid, and clean/erased. The valid state indicates that the data is valid. The invalid state indicates that the data is invalid because it has been moved to another location, usually another block. The clean/erased state indicates that the quantum has been erased and has not been written to. The invalid information is essentially a code that represents the state of the quantum. The invalid information allows the wear-level controller 220, the data collector 230, and the set classifier 240 to decide on the appropriate action to be performed when a triggering event takes place. The triggering event may be an event that requires action from the wear-level controller 220, the data collector 230, and the set classifier 240. It may be an event that indicates a data collection, or a garbage collection, is about to be performed. It may be an event that indicates a dynamic or a static wear leveling is to be performed. The triggering event may be a result of a condition or a set of conditions that has been satisfied.

The wear level controller 220 may control wear level operations on the flash device using the IQT 210. It may perform a static wear leveling and a dynamic wear leveling as appropriate. Any specific type of procedures or algorithms for the static and dynamic wear leveling may be used.

The data collector 230 may perform data collection (DC) on the plurality of blocks when a DC condition is, or DC conditions are, met. A DC condition is a condition where the data collection, or garbage collection, is performed. The data collection may be performed when it is desired to free up invalid data so that more clean quanta may become available for writes. As an illustration, one simple condition is when a DC threshold is reached. The DC threshold may be established as a function of the number of the blocks and the number of quanta in each block. It may be set as a ratio of the number of clean/erased quanta and the total number of quanta. When the number of clean/erased quanta becomes low, i.e., when it exceeds (is less than) the DC threshold, the data collection event is triggered and the data collector 230 begins the data collection process. As is known by one skilled in the art, the DC threshold is merely an illustrative example. Any other conditions may be used. The data collection is performed by moving (e.g., copying) the valid quanta in block A to other locations in other blocks and then the block A is erased, rendering the block completely free for program/write operations. The selection of the source block and the destination block may be performed by using the sets classified by the set classifier 240 discussed below. The data collector 230 may include a wear-level table 232 and a data transfer circuit 234. The wear level table 232 stores the wear levels, e.g., the number of erasures of a block, for all the blocks in the flash device 140. The data transfer circuit 234 transfers or copies valid data from a source block to a destination block.

The set classifier 240 is coupled to the IQT 210, the wear level controller 220, and the data collector 230 to classify the blocks in the flash device 140 into five different sets. These sets are: a current static set, a next static set, a completely dynamic (CD) set, a mixed set, and a free set. The classification is essentially a labeling process which labels a block as one of the above five sets using the invalid information in the IQT 210, the wear levels in the wear level table 232, and the wear level threshold WLT. Based on the information provided by the IQT 210 and the wear level table 232, the blocks are classified or labeled each time the information contained in these tables changes.

The classification of the blocks into the above five sets provides a high-level description of the blocks that enables the wear-level controller 220 and the data collector 230 to perform intelligent decisions so that wear-leveling and data collection may be carried out realistically and naturally. The classification is not tied to specific wear level or data collection algorithms. Rather, it provides high-level contextual information from which behavior-rich interpretations may be obtained.

The set classifier 240 classifies a block in the plurality of blocks into: (1) the current static set when the block has only valid with static (or cold) data and clean quanta, and the wear level is below or equal to the wear level threshold WLT, (2) the next static set when the block has only valid with static (or cold) data and clean quanta, and the wear level is above the wear level threshold WLT, (3) the completely dynamic (CD) set when the block contains all invalid quantum data, (4) the mixed set when the block has a mix of valid and invalid quanta, (5) the free set when the block from the CD set has just been erased with no concept of wear level.

The set classifier 240 may perform the classification at any one or any combination of the following scenarios: (1) When information about the blocks in the set changes. This information may include data program/write, block erasure, and data copying from a valid quantum; (2) Each time data collection is triggered; and (3) periodically at some pre-determined time frequency.

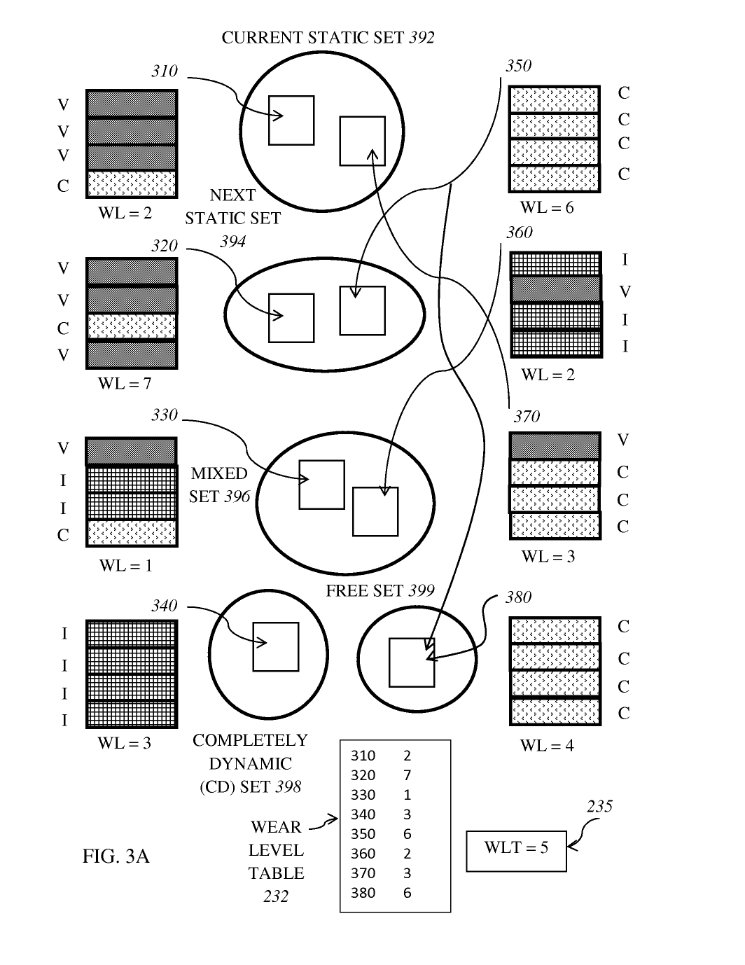

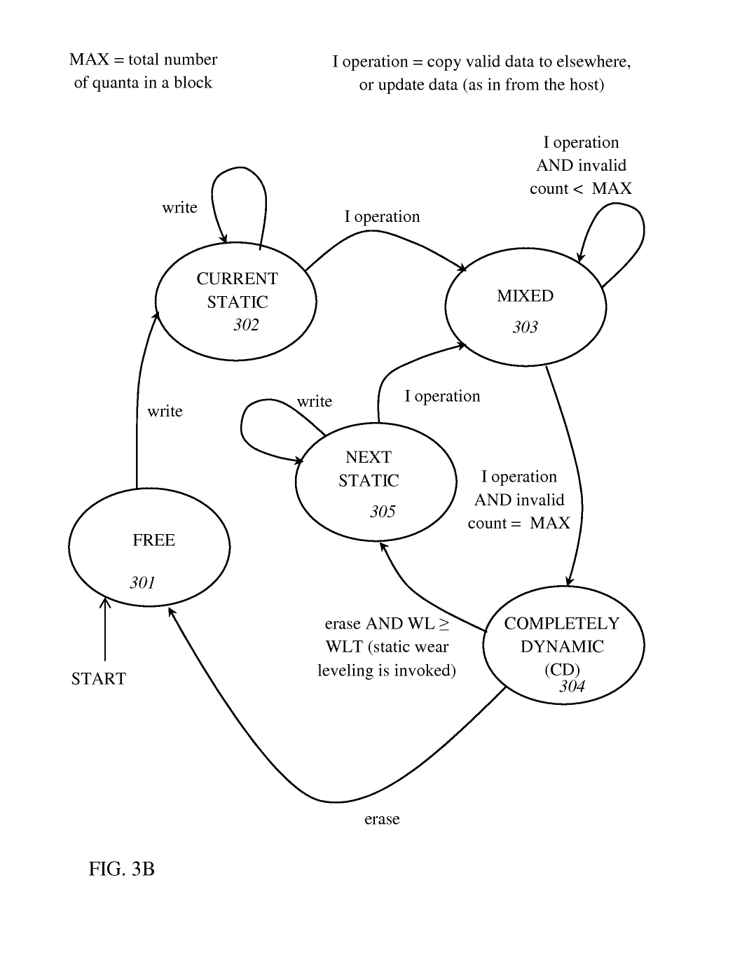

FIG. 3A is a diagram illustrating the sets for the blocks according to one embodiment. In this example, suppose there are 8 blocks 310, 320, 330, 340, 350, 360, 370, and 380. Each block has 4 quanta, e.g., 4 pages. Each quantum is coded by the invalid information stored in the IQT 210. There are three codes: V for valid, I for invalid, and C for clean/erased. The wear levels of the blocks are stored in the wear level table 232. Suppose the wear level threshold WLT is 5. Block 310 has only V and C quanta and the wear level is 2<WLT: block 310 is classified as belonging to the current static set 392. Block 320 has only V and C quanta and the wear level is 7>WLT: block 320 is classified as belonging to the next static set 394. Block 330 has a mix of V and I quanta: block 330 is classified as belonging to mixed set 396. Block 340 has 4 I's, all quanta are invalid: block 340 is classified as belonging to the completely dynamic set 398. Block 350 has 4 C's, all quanta are clean and wear level is 6>WLT: it may be classified as belonging to the next static set 394 according to a wear level algorithm or it may be classified as belonging to the free set 399. Block 360 has a mix of V and I quanta; like block 330, it is classified as belonging to the mixed set 396. Block 370 has only V and C quanta and its wear level is 3<WLT: it is classified as belonging to the current static set 392. Block 380 has 4C's, all quanta are clean and its wear level is 4<WLT: it is classified as belonging to the free set 399.

It should be noted that by having over provision blocks, i.e., those extra blocks that are provided more than the initial usage, there will never be the case where both the CD set 398 and the mixed set 396 are empty, except at the initial state.

FIG. 3B is a diagram illustrating a state diagram for the set classification according to one embodiment. A block may go through the classification each time there is a change in the quanta. There are five states: free 301, current static 302, mixed 303, completely dynamic 304, and next static 305. Each of the states corresponds to the classification of the block into the corresponding set. An I operation is an operation that results in invalid quanta, such as a copy operation that copies the data to some other location, or update data as in from the host processor. MAX is the total number of quanta in the block.

Initially, all blocks are completely erased, the wear level WL is 0, and are in the free state 301. When there is a write or program cycle that writes to a quantum in the block with valid data, the block transitions from the free state 301 to the current static state 302. In the current static state 302, the block has only valid or clean quanta. While in current static state 302, any additional writes of valid data to the block results in the same state as long as all quanta remain valid or clean. As soon as there is an I operation on the block, the block transitions from the current static state 302 to the mixed state 303. In the mixed state 303, the block contains a mix of valid and invalid quanta. From the mixed state 303, any additional writes or I operations that continue to keep the block to have a mix of valid and invalid quanta (i.e., the invalid count is less than MAX) return the block back to the same mixed state 303. It should be noted that it is possible for a block in the mixed state 303 to have its wear level to be greater than or equal to the wear level threshold. For example, when by chance that the host processor changes the usage of cold (static) data and makes them hot (dynamic) data. When there is an I operation that results in the block having all invalid quanta, i.e., the invalid count is equal to MAX, the block transitions from the mixed state 303 to the completely dynamic state 304. From the CD state 304, when there is an erasure and there is no relevant static wear leveling operation, the block transitions to the free state 301. From the CD state 304, when there is an erasure and the wear level WL of the block is greater than or equal to the wear level threshold WLT and there is a relevant static wear leveling operation, the block transitions to the next static state 305. Typically, at this state, a static wear leveling is invoked. The static wear leveling copies a block in a current static set to this block. In one embodiment, a block that has its wear level greater than or equal to the wear level threshold and is transitioned from the mixed state 303 to the CD state 304 may be kept tracked by using a marker bit so that when it is erased it can be selected as a destination block for data collection. From the next static state 305, if there is an I operation the block transitions to the mixed state 303. From the next static state 305, any additional writes of valid data to the block results in the same state as long as all quanta remain valid or clean.

It should be noted that the state diagram in FIG. 3B only illustrates the transition of a block from one state (in a corresponding set) to another state. It does not show any possible dynamic or static wear leveling process performed on the block.

When data collection occurs, the data are transferred based on the classified sets. In one embodiment, the data collection will focus on the mixed set and the CD set in order to facilitate a dynamic wear level process. In addition, static wear level process may be carried out and rotate blocks among the sets.

There are two scenarios: the CD set is empty and the CD set is not empty.

When the CD set is empty, it means that there is no block that has all invalid quanta. Therefore, no block can be readily erased to become free, i.e., available for receiving valid data transferred from other blocks. As data are copied from valid quanta to another block, the quanta having the data copied will become invalid. Eventually, more and more quanta become invalid and a block will eventually have all invalid quanta and will be classified as belonging to the CD set 398. At this point, the scenario will become the scenario where the CD set is not empty.

When the CD set is not empty, there is at least one block that has all invalid quanta and therefore it may be erased. In one embodiment, when there are multiple blocks in the CD set, selecting a block for erasure may be based on the wear level. For example, the block that has the highest wear level may be selected. Another selection criteria may be to select any block in a subset in which all blocks have wear levels to be greater than or equal to the wear level threshold. When a block is erased, its wear level is updated, e.g., incremented, in the wear level table 232. For a static wear leveling, static data will be moved to more worn blocks. For a dynamic wear leveling, the block with the lowest erase count in the wear level table 232 may be selected for the next write.

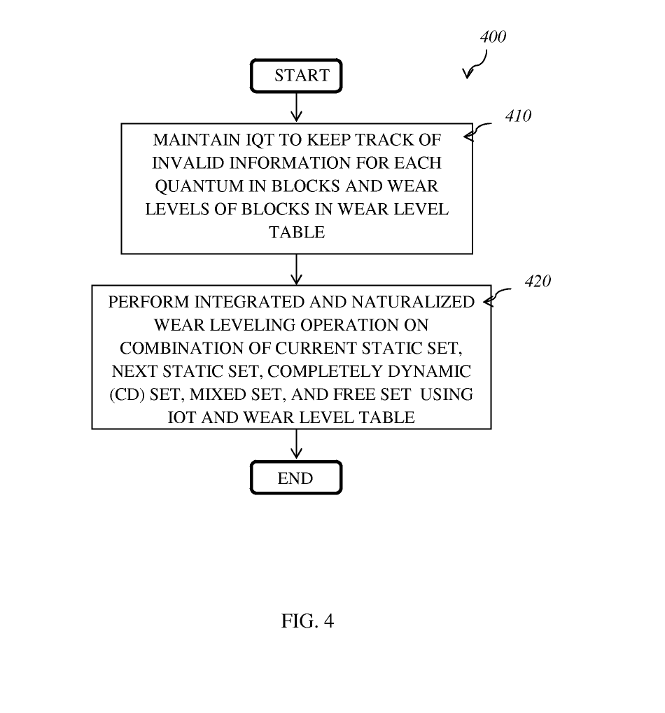

FIG. 4 is a flowchart illustrating a process 400 to perform an integrated wear level operation according to one embodiment.

Upon START, the process 400 maintains an invalid quantum table to keep track of invalid information for each quantum in a plurality of blocks in a flash device (Block 410). Next, the process 400 performs an integrated and naturalized wear leveling operation on a combination of a current static set, a next static set, a completely dynamic (CD) set, a mixed set, and a free set using the invalid information (Block 420). The process 400 is then terminated.

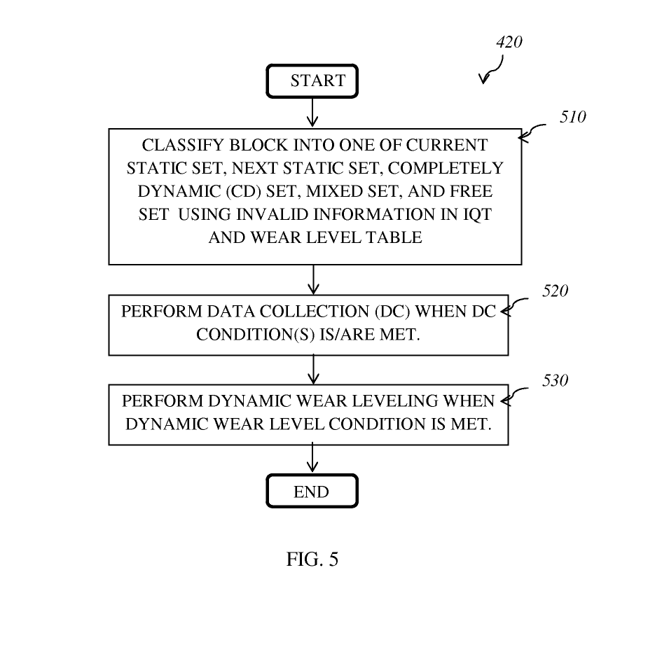

FIG. 5 is a flowchart illustrating the process 420 to perform an integrated and naturalized wear leveling according to one embodiment.

Upon START, the process 420 classifies a block into one of the current static set, the next static set, the completely dynamic (CD) set, the mixed set, and the free set using the invalid information in the IQT and the wear level in the wear level table (Block 510). Next, the process 420 performs a data collection (DC) when a DC threshold is reached (Block 520). Then, the process 420 performs a dynamic wear leveling when a dynamic wear level condition is met (Block 530). The dynamic wear level condition may be any appropriate condition as determined by the dynamic wear level procedure. As an illustration, a simple dynamic wear level condition may be a condition when a program or write process is being, or about to be, performed. The process 420 is then terminated.

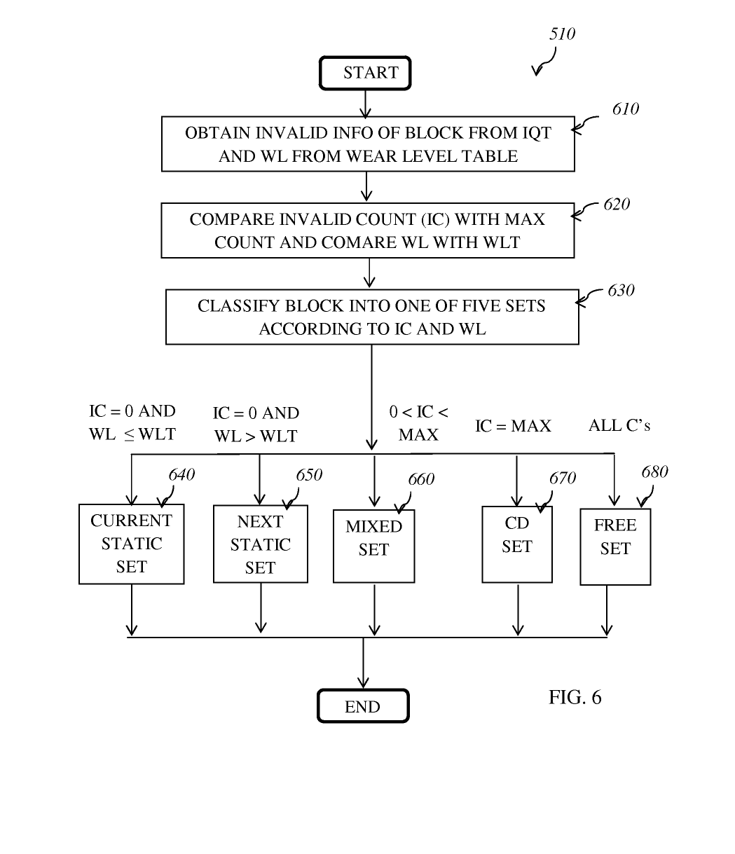

FIG. 6 is a flowchart illustrating the process 510 to classify a block according to one embodiment.

Upon START, the process 510 obtains invalid count (IC) of the block using invalid information (Block 610). This may be performed by adding the total number of invalid quanta in the block. Next, the process 510 compares the invalid count with the maximum count MAX and the wear level WL of the block with the wear level threshold WLT (Block 620). The maximum count MAX is the maximum number of quanta in a block. Then the process 510 classifies the block into one of the five sets based on the IC and the WL (Block 630). If IC<MAX and WL<WLT, the process 510 classifies the block into the current static set (Block 640) and is then terminated. If IC=0 and WL≧WLT, the process 510 classifies the block into the next static set (Block 650) and is then terminated. If 0<IC<max count MAX, the process 510 classifies the block into the mixed set (Block 660) and is then terminated. If IC=max count MAX, or the block contains all invalid quanta, the process 510 classifies the block into the completely dynamic (CD) set (Block 670) and is then terminated. If the block contains all clean (C) quanta and WL<WLT, the process 510 classifies the block into the free set (Block 680) and is then terminated.

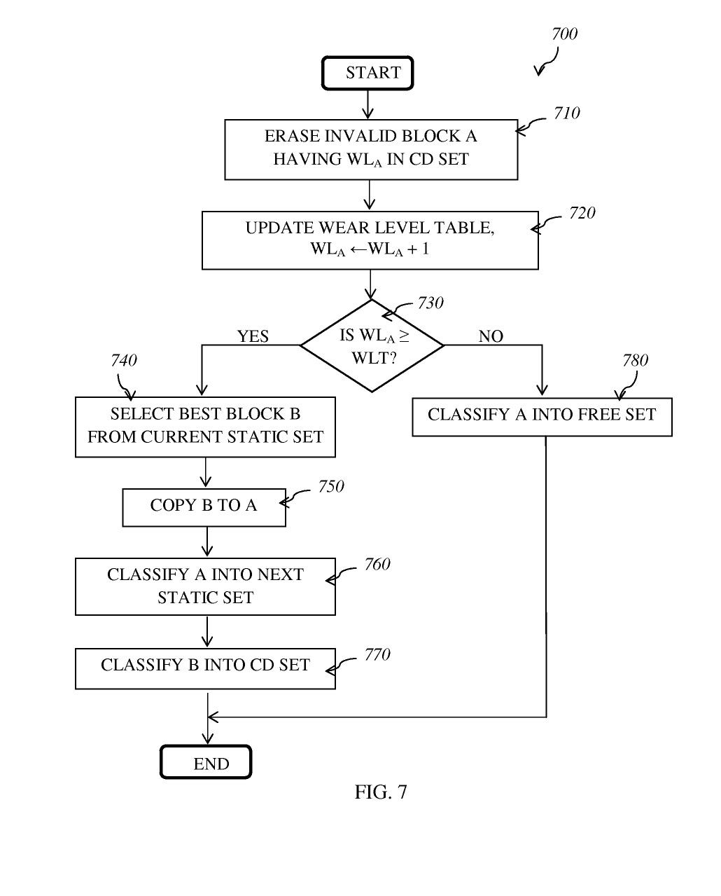

FIG. 7 is a flowchart illustrating a process 700 to perform a static wear leveling according to one embodiment.

Upon START, the process 700 erases an invalid block A having a wear level WL_{A} in the CD set (Block 710). Next, the process 700 updates the wear level table (Block 720). This may include increment an erase count for the invalid block A that has just been erased in Block 710, i.e., WL_{A}←WL_{A}+1. Then, the process 700 determines if the updated wear level WL_{A} is greater than or equal to the wear level threshold WLT (Block 730). It should be noted that the static wear level set is only activated when the condition WL_{A}=WLT is at least met. If so, the process 700 selects a best block B from the current static set as a candidate to transfer data (Block 740). Then, the process 700 copies the data in the selected block B to block A (Block 750). Next, the process 700 classifies block A into the next static set (Block 760). Block B is now completely invalid because its entire content has been copied to block A. Therefore, the process 700 classifies block B into the CD set (Block 770) and is then terminated. If the wear level WLA is not greater than the wear level threshold WLT, the process 700 classifies A into the free set (Block 780) and is then terminated. The free set is now available for writes.

The classification of a block into a current static set, a next static set, a completely dynamic (CD) set, a mixed set, and a free set, is useful in wear leveling operations and DC techniques. In one embodiment, a FIFO structure may be used to implement a static wear leveling.

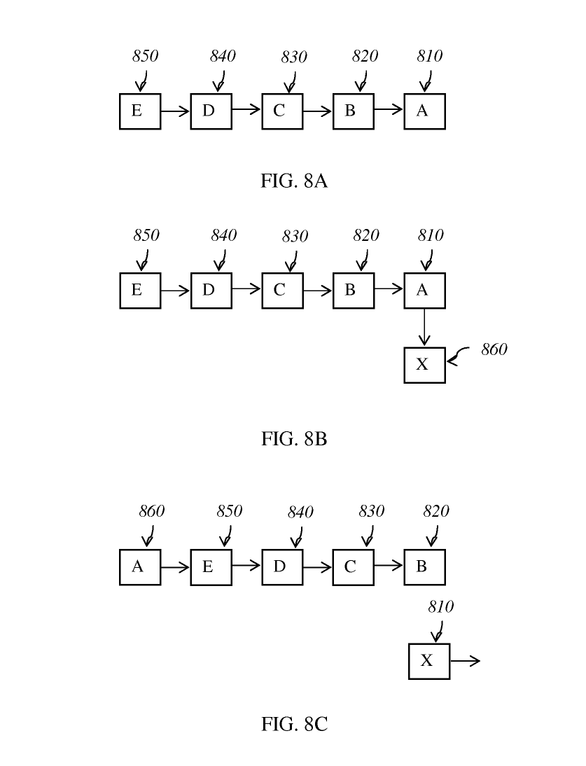

FIGS. 8A, 8B, and 8C are diagrams illustrating the use of a first-in-first-out (FIFO) structure for static wear leveling according to one embodiment. The FIFO structure may be implemented by a set of pointers to the linked blocks.

FIG. 8A illustrates a basic FIFO structure. In this illustrative example, the FIFO has five elements 810, 820, 830, 840, and 850 that store the data A, B, C, D, and E, respectively. The element 810 is referred to as the front, or head, of the FIFO and the element 850 is referred to as the end, or tail, of the FIFO. The FIFO may be referred to as a queue. New elements enter the queue at the end and elements leave the queue from the front. There are three basic operations that may be performed on the FIFO. A pop operation retrieves the element from the front. A push operation puts an element into the queue at the end. A remove operation removes an element, not at the front, from the queue. When an element is removed the links, or pointers, before and after this element are joined together to maintain the FIFO nature of the queue. When the FIFO is implemented in the static pool, each element may be a block. As blocks in the FIFO undergo read and write cycles, data may be read and written. Accordingly, a block in a FIFO static pool may be classified into different sets. When a block is classified as mixed or invalid, it is removed from the FIFO by the remove operation so that the FIFO static pool always contains valid static data.

FIG. 8B is a diagram illustrates a pop operation. A block 860 is erased and is selected for data copying. It may have an erase count less than or equal to the wear level threshold or greater than wear level threshold. The block 810 is popped from the FIFO. Its data A is then copied into the block 860.

FIG. 8C is a diagram illustrates a push operation. The block 860 which now contains the copied data A is pushed into the FIFO at the end of the FIFO. The block 810 is erased and may be classified into an appropriate set such as the free set.

When it is time to do a static wear leveling, a block may be selected from the static set (either current static set or next static set). By using the FIFO, the blocks may be naturally arranged such that the block at the front of the FIFO contains the most static data and therefore is the best candidate to be used for static wear leveling. The block that contains the least static data may be pushed into the FIFO at the end. As blocks go through read/write and Program/Erase cycles, they leave the FIFO and enter the FIFO such that the nature of the static data is automatically maintained, i.e., the block at the front contains the most static data and ordered sequentially through the FIFO till the end where the block contains the least static data.

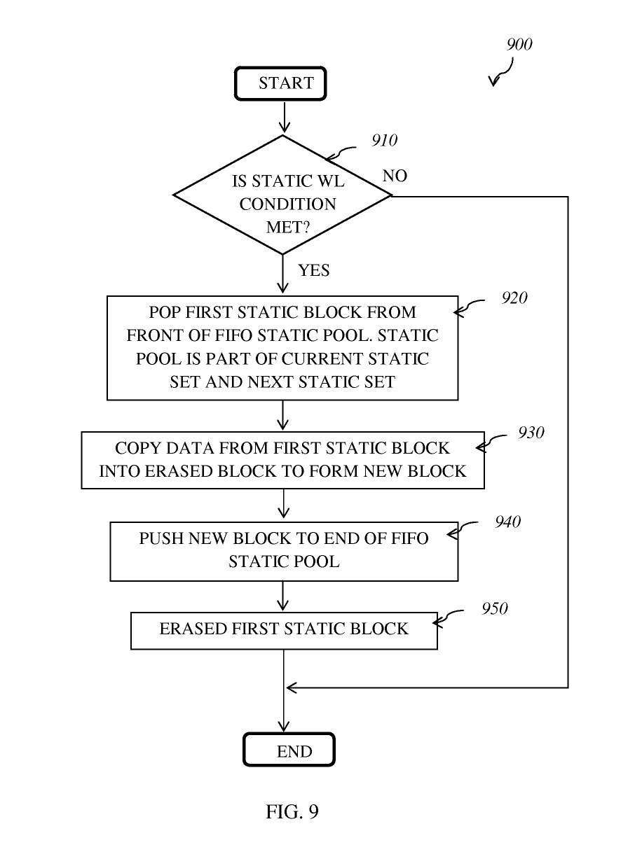

FIG. 9 is a flowchart illustrating a process 900 to perform static wear leveling using the FIFO structure according to one embodiment.

Upon START, the process 900 determines if a static wear leveling condition is met (Block 910). The static wear leveling condition is a condition where it is determined that a static wear leveling is to be performed. For example, this condition may be met when the standard deviation of the erase counts of all the blocks exceeds a pre-defined threshold, indicating that the blocks are not evenly worn out. If not, the process 900 is terminated. Otherwise, the process 900 pops a first static block from front of a FIFO static pool (Block 920).

Next, the process 900 copies data from the first static block into an erased block to form a new block (Block 930). Then, the process 900 pushes the new block to end of the FIFO static pool (Block 940). Next, the process 900 erases the first static block after copying the data (Block 950) and is then terminated.

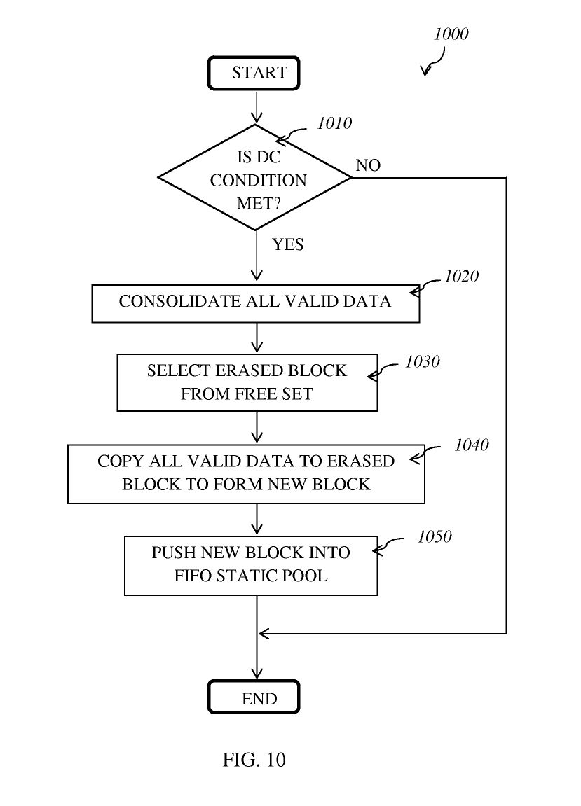

FIG. 10 is a flowchart illustrating a process 1000 to maintain the FIFO static pool according to one embodiment. Since data collection naturally wears out the blocks, it is natural for the processor or process responsible for data collection to maintain the static pool.

Upon START, the process 1000 determines if a data collection (DC) condition is met (Block 1010). This DC condition is a condition when it is determined that a data collection is to be performed. For example, this condition may be met when the number of blocks available for write becomes less than a pre-defined threshold or when the blocks become severely defragmented because valid data are scattered all over the blocks. Next, the process 1000 consolidates all valid data (Block 1020). This may be performed by selecting quanta of valid data in one or more blocks which contain mostly invalid data and merging the quanta of these valid data to fit within the erased block.

Next, the process 1000 selects an erased block from a free set (Block 1030). The free set is a set which contains blocks that have wear levels less than a pre-defined wear level threshold. Then, the process 1000 copies all consolidated data into the erased block to form a new block (Block 1040). Next, the process 1000 pushes the new block to a FIFO static pool (Block 1050) and is then terminated.

Elements of one embodiment may be implemented by hardware, firmware, software or any combination thereof. The term hardware generally refers to an element having a physical structure such as electronic, electromagnetic, optical, electro-optical, mechanical, electro-mechanical parts, etc. A hardware implementation may include analog or digital circuits, devices, processors, applications specific integrated circuits (ASICs), programmable logic devices (PLDs), field programmable gate arrays (FPGAs), or any electronic devices. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory, ROM, EPROM). Examples of firmware may include microcode, writable control store, micro-programmed structure. When implemented in software or firmware, the elements of an embodiment may be the code segments to perform the necessary tasks. The software/firmware may include the actual code to carry out the operations described in one embodiment, or code that emulates or simulates the operations. The program or code segments may be stored in a processor or machine accessible medium. The “processor readable or accessible medium” or “machine readable or accessible medium” may include any non-transitory medium that may store information. Examples of the processor readable or machine accessible medium that may store include a storage medium, an electronic circuit, a semiconductor memory device, a read only memory (ROM), a flash memory, an erasable programmable ROM (EPROM), a floppy diskette, a compact disk (CD) ROM, an optical disk, a hard disk, etc. The machine accessible medium may be embodied in an article of manufacture. The machine accessible medium may include information or data that, when accessed by a machine, cause the machine to perform the operations or actions described above. The machine accessible medium may also include program code, instruction or instructions embedded therein. The program code may include machine readable code, instruction or instructions to perform the operations or actions described above. The term “information” or “data” here refers to any type of information that is encoded for machine-readable purposes. Therefore, it may include program, code, data, file, etc.

All or part of an embodiment may be implemented by various means depending on applications according to particular features, functions. These means may include hardware, software, or firmware, or any combination thereof. A hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method comprising:
popping a first static block from front of a first-in-first-out (FIFO) static pool when a static wear leveling condition is met;
copying data from the first static block into an erased block to form a new block; and
pushing the new block to end of the FIFO static pool,
wherein the static pool is part of a current static set and a next static set.

2. The method of claim 1 further comprising:
erasing the first static block after copying the data.

3. The method of claim 1 further comprising:
removing a second block in the FIFO static pool when the second block becomes invalid or mixed.

4. A method comprising:
consolidating all valid data when a data collection condition is met;
selecting an erased block from a free set;
copying all consolidated data into the erased block to form a new block; and
pushing the new block to a first-in-first-out (FIFO) static pool,
wherein the static pool is part of a current static set and a next static set.

5. The method of claim 4 wherein the instructions causing the processor to perform consolidating all valid data comprise instructions that cause the processor to perform operations comprising:
selecting quanta of valid data in at least a block where a majority of blocks in the at least a block contain invalid data; and
merging the quanta of valid data to fit within the erased block.

6. The method of claim 4 wherein the free set contains erased blocks that are available for use.

7. A circuit comprising:
a processor;
a memory coupled to the processor, the memory storing instructions that, when executed, cause the processor to perform operations comprising:
popping a first static block from front of a first-in-first-out (FIFO) static pool when a static wear leveling condition is met;
copying data from the first static block into an erased block to form a new block; and
pushing the new block to end of the FIFO static pool,
wherein the static pool is part of a current static set and a next static set.

8. The circuit of claim 7 wherein the instructions further comprises instructions that cause the processor to perform operations comprising:
erasing the first static block after copying the data.

9. The circuit of claim 7 wherein the instructions further comprises instructions that cause the processor to perform operations comprising:
removing a second block in the FIFO static pool when the second block becomes invalid or mixed.

10. A circuit comprising:
a processor; and
a memory coupled to the processor, the memory storing instructions that, when executed, cause the processor to perform operations comprising:
consolidating all valid data when a data collection condition is met,
selecting an erased block from a free set,
copying all consolidated data into the erased block to form a new block, and
pushing the new block to a first-in-first-out (FIFO) static pool,
wherein the static pool is part of a current static set and a next static set.

11. The circuit of claim 10 wherein the instructions causing the processor to perform consolidating all valid data comprises instructions that cause the processor to perform operations comprising:
selecting quanta of valid data in at least a block where a majority of blocks in the at least a block contain invalid data; and
merging the quanta of valid data to fit within the erased block.

12. The circuit of claim 10 wherein the free set contains erased blocks that are available for use.
